(19) United States
(12) Patent Application Publication
(10) Pub. No.: US 2009/0153300 A1
(43) Pub. Date: Jun. 18, 2009

(54) RFID TRANSPONDER WITH HIGH DOWNLINK DATA RATE

(75) Inventor: Herbert Meier, Moosburg (DE)

Correspondence Address: TEXAS INSTRUMENTS INCORPORATED, P O BOX 655474, M/S 3999, DALLAS, TX, 75265, US

(73) Assignee: TEXAS INSTRUMENTS DEUTSCHLAND, GMBH, Freising (DE)

(21) Appl. No.: 12/253,027

(22) Filed: Oct. 16, 2008

(30) Foreign Application Priority Data
Oct. 16, 2007 (DE) 10 2007 049 560.0

(51) Int. Cl. H04Q 5/22

(52) U.S. Cl. 340/10.1

(57) ABSTRACT

A RFID transponder includes a high quality factor antenna, and a resonance capacitor coupled to the high quality factor antenna for providing a resonant circuit. The RFID transponder has a symmetrical RF input stage and is adapted to vary the quality factor of the resonant circuit such that the quality factor is low during downlink data transmission when the RFID transponder receives data through the antenna, and the quality factor is high during uplink data transmission, when the RFID transponder transmits data.

### FIELD OF THE INVENTION

The present invention relates to a RFID transponder and a RFID system including a RFID transponder for fast downlink data transmission.

### BACKGROUND OF THE INVENTION

RFID systems include RFID transponders and read/write units (R/W-unit) for writing data to the RFID transponder (downlink) or for reading data from a RFID transponder (uplink). The RFID transponder front end has a high quality inductor, which is used as antenna and a resonant capacitor coupled to the antenna. The inductive antenna and the resonant capacitor form a resonant circuit, which is excited by an external RF signal from the R/W-unit during downlink. For passive RFID transponders, the received RF signal is rectified and converted into an internal supply voltage for supplying the RFID transponder. The downlink data transmission is typically performed by a 100% amplitude shift keying modulation. According to this modulation, the R/W-unit sends bursts of RF signals and the RFID transponder determines based on the length of the bursts and pauses between the bursts the data to be received. For uplink data transmission, many RFID transponders use frequency shift keying (FSK). For charging the RFID transponder by use of the RF signal from the R/W-unit and during uplink data transmission, a high quality factor of the resonant circuit is advantageous. However, in order to perform a fast high bandwidth downlink data transmission, a low quality factor of the resonant circuit is preferable.

### SUMMARY OF THE INVENTION

It is a general object of the present invention to provide a RFID system and a RFID transponder having an improved performance compared with prior art RFID transponders.

A RFID transponder according to an aspect of the present invention comprises a high quality factor antenna and a resonance capacitor coupled to the high quality factor antenna for providing a resonant circuit. The RFID transponder has a symmetrical RF input stage and is adapted to vary the quality factor of the resonant circuit such that the quality factor is low during downlink data transmission when the RFID transponder receives data through the antenna and the quality factor is high during uplink data transmission, when the RFID transponder transmits data. The symmetrical RF input stage includes limiter circuits and trimming circuits as well as the necessary components to switch between a high quality factor and a low quality factor of the resonant circuit. Accordingly, a RFID transponder according to the present invention is capable of switching the quality factor of the resonant circuit in order to adapt to different conditions. This allows for a very high data rate during downlink, as the pauses between bursts of the received RF signal can be very short. On the other hand, it is still possible to effectively charge the RFID transponder when switched to a high quality factor. Also, during uplink the higher quality factor can be used. For the same field strength of the external RF signal from the R/W-unit, the amplitudes of the voltage across the resonant circuit in the RFID transponder are greater for a high quality factor than for a low quality factor of the resonant circuit. With a single ended input stage the RFID transponder must have two demodulation stages, one for each quality factor or a single demodulation stage with self-adjusting reference levels. However, the symmetrical input stage allows a single demodulation stage to be used that must not be adapted when the quality factor is changed. The symmetrical input stage allows the pauses between bursts of RF oscillations to be safely detected. The symmetrical input stage includes two symmetrical portions each including a limiter element and a trimming circuit coupled between a first node of the resonant circuit and ground and a second node of the resonant circuit and ground. Since the RF signal oscillates symmetrically around ground level, i.e. the voltage level at the first node and the voltage level at the second node are symmetrical with respect to ground.

Advantageously, the quality factor is also high during a charging phase, when the transponder is charged through a received RF signal. This increases efficiency for passive transponders. However, RFID transponders using a battery can also profit from aspects of the present invention.

According to an aspect of the present invention, the RFID transponder includes a single demodulation stage adapted to detect an end-of-burst of a RF signal received using the high-quality factor and adapted to detect an end-of-burst of a RF signal received using the low quality factor by use of the same reference detection level. The benefit of having a symmetrical input stage is that a single demodulation stage can be used, as the detection level or reference level used for demodulation can remain unchanged irrespective of the selected quality factor.

According to aspects of the present invention, the detection level of the demodulation stage (i.e. of the end of burst detector) is adjustable or self-adjusting. Preferably, the detection level is determined based on a ground level or a supply voltage level or derived from the signal at the first node, to which the end of burst detector can be coupled. Advantageously, an envelope signal of the signal at the first node is generated and used to determine an optimum detection level.

The RFID transponder according to an aspect of the present invention includes further a rectifying means for rectifying the received RF signal adapted to rectify different half-waves of the received RF signal separately and to generate a first supply voltage from one half-wave and a second supply voltage from the other half-wave. Having two independent supply voltages provides a higher flexibility and allows a first voltage supply to rise faster during a charge or recharge phase than a second voltage supply.

The first supply voltage can be used for supplying analog circuitry and the second supply voltage can be used for supplying digital circuitry of the RFID transponder. In a situation where the analog parts consume more power than the digital parts, this configuration provides that the second supply voltage level increases faster during a charging phase and remains longer at a higher supply voltage level. This provides for a safe and early initialization of the digital circuitry included in the RFID transponder. However, in another preferred configuration, only a single supply voltage is used, to reduce complexity of the circuitry.

The high quality inductor and the resonance capacitor are coupled to each other at a first node and a second node to form the resonant circuit. The RFID transponder further includes a series of a first damping resistor and a first damping capacitor adapted to be selectively coupled between the first node and ground. A series of a second damping resistor and a second damping capacitor is adapted to be selectively coupled between the second node and ground. The selective coupling can be performed by switches coupled in series to the damping capacitors. The quality factor of the resonant circuit is then lower if the series of capacitor and resistor are coupled to the resonant circuit. Using a series of capacitor and resistor reduces power consumption compared with a resistor, only.

In an alternative configuration, the RFID transponder according to an aspect of the present invention can only have a first damping resistor adapted to be selectively coupled between the first node and ground, and a second damping resistor adapted to be selectively coupled between the second node and ground. The first and second node should then be decoupled from any supply voltage node by diodes (e.g. the diodes of a bridge rectifier) in order to prevent current from flowing back into the first and second node from the supply voltage nodes. However, omitting the damping capacitors increases the damping factor (i.e. the variation of the quality factor) and allows the data rate to be increased even more than with damping capacitors.

A RF transponder according to an aspect of the present invention can comprise an oscillation maintenance stage. The oscillation maintenance stage serves to maintain an oscillation of the resonant circuit in a situation when no external RF signal is received. This is implemented by two resistors coupled periodically between the first node and ground and the second node and ground. The two resistors from the oscillation maintenance stage can also be used as the first and the second damping resistor.

The present invention also relates to a RFID system having a R/W-unit and a RFID transponder. The RFID transponder is implemented as set out hereinabove.

The present invention also relates to a method of operating a RFID transponder. The resonant circuit of the RFID transponder is switched to a low quality factor during downlink data transmission and to a high quality factor during uplink data transmission by use of a symmetrical damping means. Further, a first supply voltage is generated from a first half-wave of a received RF signal and a second supply voltage is generated from a second half-wave of the received RF signal. The first supply voltage can be used for supplying analog parts and the second supply voltage can be used for supplying digital parts of the RFID transponder.

Further aspects of the present invention will ensue from the description hereinbelow of a preferred embodiment of the present invention with reference to the accompanying drawings, wherein:

### BRIEF DESCRIPTION OF THE DRAWINGS

FIG. 1 shows a simplified circuit diagram of a first embodiment of the present invention,

FIG. 2 shows a simplified circuit diagram of a second embodiment of the present invention,

FIG. 3 shows a simplified circuit diagram of a third embodiment of the present invention,

FIG. 4 shows a waveform of the received RF signal relating to the first embodiment of the present invention,

FIG. 5 shows a waveform of the received RF signal relating to the third embodiment of the present invention,

FIG. 6 shows a waveform of a voltage level of the third embodiment of the present invention,

FIG. 7 shows a waveform of a supply voltage level of the third embodiment of the present invention relating to FIG. 6,

FIG. 8 shows a waveform of a voltage level of the third embodiment of the present invention,

FIG. 9 shows a waveform of a supply voltage level of the third embodiment of the present invention relating to FIG. 8,

FIG. 10 shows the waveforms of FIGS. 9 and 7 in a single diagram,

FIG. 11 shows a waveform of an end of burst signal of the third embodiment of the present invention,

FIG. 12 shows a waveform of the received RF signal relating to the second embodiment of the present invention, and

FIG. 13 shows a waveform of the received RF signal relating to the second embodiment of the present invention.

### DETAILED DESCRIPTION OF THE INVENTION

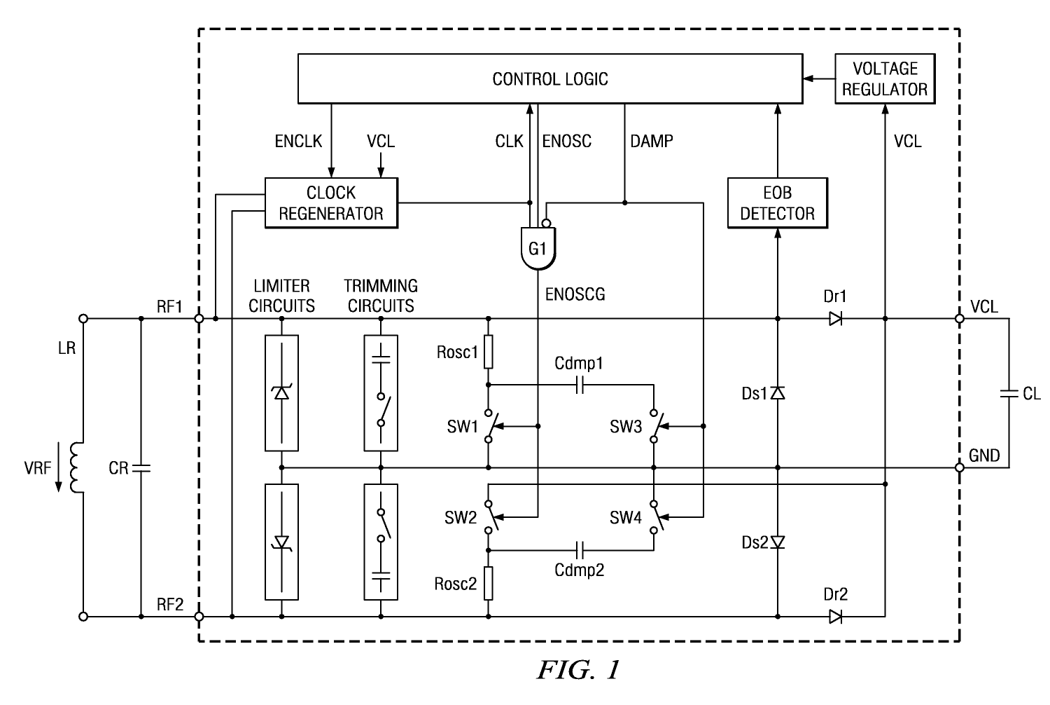

FIG. 1 shows a simplified circuit diagram of a first embodiment of the present invention. The first embodiment shown in FIG. 1 has a symmetrical input stage and a bridge rectifier including Dr1, Dr2, Ds1, Ds2. The resonant circuit LR, CR is trimmed by the trimming circuits to a certain resonance frequency. When the transponder is exposed to a field of a reader unit (R/W-unit) transmitting the resonance frequency, the charge capacitor CL is charged by the bridge rectifier (charge phase) and the supply voltage VCL is established. Diodes Ds1 and Ds2 are typically implemented as substrate diodes in an integrated circuit. The maximum charge voltage is restricted by the limiter circuits coupled between ground GND and a first node RF1 and a second node RF2. The first and the second node RF1 and RF2 have the same threshold levels. In the very simple situation (read-only transponder) the transponder responds by using frequency shift keying (FSK) directly after the charge phase. The end-of-burst detector EOB is coupled to the first node RF1 for detecting an end-of-burst of the RF signal received through the resonant circuit LR, CR. The internal supply voltage VCL is fed to a voltage regulator, which provides a constant supply voltage to the control logic stage CNTL. There is further a clock regenerator, an AND gate G1 and two resistors Rosc1 and Rosc2. The resistors Rosc1 and Rosc2 are periodically coupled to ground through switches SW1 and SW2 in response to a gated oscillation enable signal ENOSCG. This signal is produced by a logical combination of a damping signal DAMP, an oscillation enable signal ENOSC, which is issued from the control logic, and a clock signal CLK produced by the clock regenerator stage. The control logic controls data transmission during uplink and downlink and issues a clock enable signal ENCLK to the clock regenerator stage if oscillation maintenance of the resonant circuit LR, CR is required. In this situation, the clock regenerator stage outputs a clock signal, which is derived from the oscillation of the resonant circuit LR, CR. This clock signal is gated with the oscillation enable signal ENOSC and the negated damp signal DAMP. If DAMP is low and ENOSC is high, the resistors Rosc1 and Rosc2 are periodically connected between RF1 and ground and RF2 and VCL by closing switches SW1 and SW2. Thereby, the oscillation of the resonant circuit LR, CR with a frequency similar to the frequency of the received RF signal is maintained.

The end-of-burst detector EOB detects the deactivation of the R/W-unit transmission and the control logic will activate the clock regenerator. The clock regenerator has to provide a digital signal, which is exactly one half-wave of the RF oscillation. This signal activates during a negative half-wave of the switch SW1 thereby connecting resistor Rosc1 to ground. Due to the symmetrical input stage, a single resistor is not sufficient to enhance the oscillation sufficiently. Therefore, the same control signal ENOSCG should be used to activate a second switch in order to connect resistor Rosc2 to the supply voltage VCL. The amplitude of the voltage VRF across the resonant circuit LR, CR is maximum two times the charge voltage. It is controlled through the resistance of resistors Rosc1 and Rosc2. In case of a read/write-transponder, data has to be transferred to the transponder (downlink). This is typically realized by a 100% amplitude shift keying (ASK). The bit coding is performed by deactivation and activation phases of the RF signal. The necessary minimum activation time, which can be detected by the end-of-burst detector EOB, depends on the quality factors of the R/W-unit and RFID transponder. In order to have high data rates during downlink, a low quality factor of the RFID transponder is desirable. The whole RFID transponder is supplied by VCL.

The oscillation maintenance resistors Rosc1 and Rosc2 are also used for adapting the quality factor of the resonant circuit LR, CR. Therefore, the first oscillation maintenance resistor Rosc1 is coupled in series with a damping capacitor Cdmp1 and a third switch SW3. Further, the second oscillation maintenance resistor Rosc2 is coupled in series with a second damping capacitor Cdmp2 and a fourth switch SW4. In order to reduce the quality factor of the resonant circuit LR, CR, the series of damping components Rosc1, Cdmp1, and Rosc2, Cdmp2 is coupled between the first node RF1 and ground and the second node RF2 and ground, respectively. This is only possible since the oscillation maintenance circuit is not required during a low Q phase, i.e. a phase during which the quality factor of the resonant circuit LR, CR is low. During high Q phases, for example uplink transmission and during charging phases, the switches SW3, SW4 are open and no damping of the resonant circuit LR, CR occurs. Although the RF input stage of the RFID transponder according to the present invention is implemented in a symmetrical manner, the additional complexity and chip area needed for the symmetrical implementation can be compensated to a certain extent, as the end-of-burst detector (demodulation stage) EOB can be simplified compared to an asymmetrical approach. If the resonant circuit LR, CR oscillates, a voltage drop VRF between the first node RF1 and the second node RF2 is present. This voltage VRF is symmetrical with respect to ground GND. If the amplitude of the voltage VRF drops, the end-of-burst detector determines whether or not the amplitude drops below a specific minimum detection level or reference level. If the amplitude of the voltage VRF becomes smaller than the detection level, an end-of-burst of a received RF signal is detected. The end-of-burst detector EOB issues a respective signal to the control logic. If this detection level is properly adjusted, it is sufficient to use only one detection level for low Q phases and high Q phases. However, for large distances between the R/W-unit it is advantageous to use an adjustable detection level. The detection level can be derived from VCL or from GND, e.g. VCL−1V or GND+1V. Further, the detection level can be derived from the signal at node RF1. If an envelope of this signal is generated, this envelope signal can be used as varying and adaptive detection level.

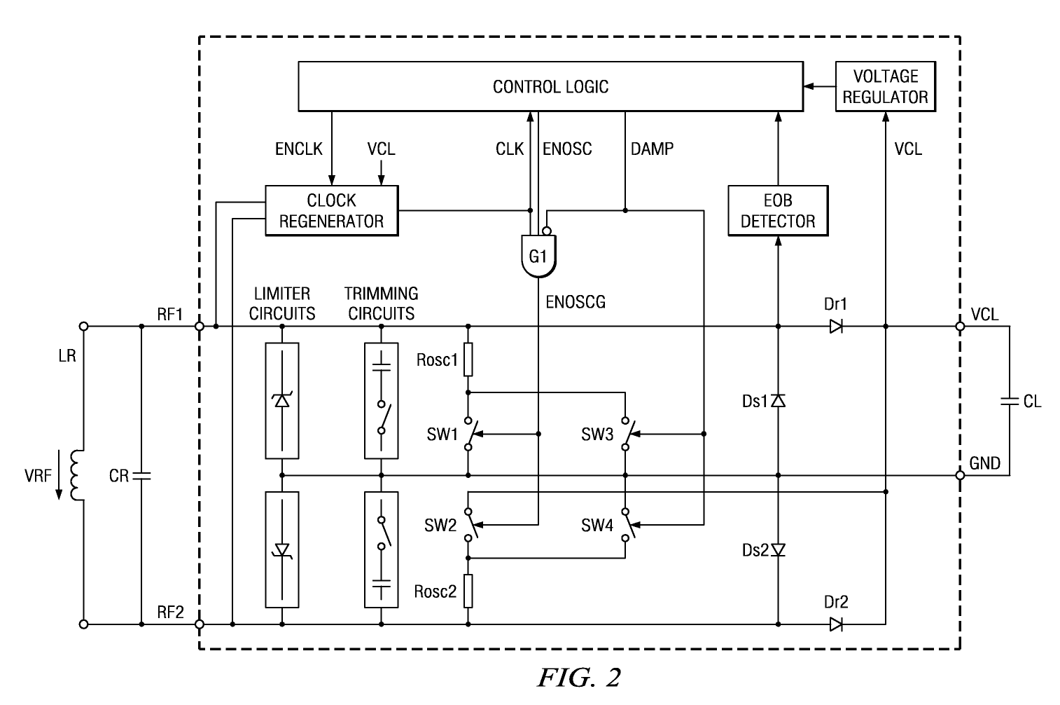

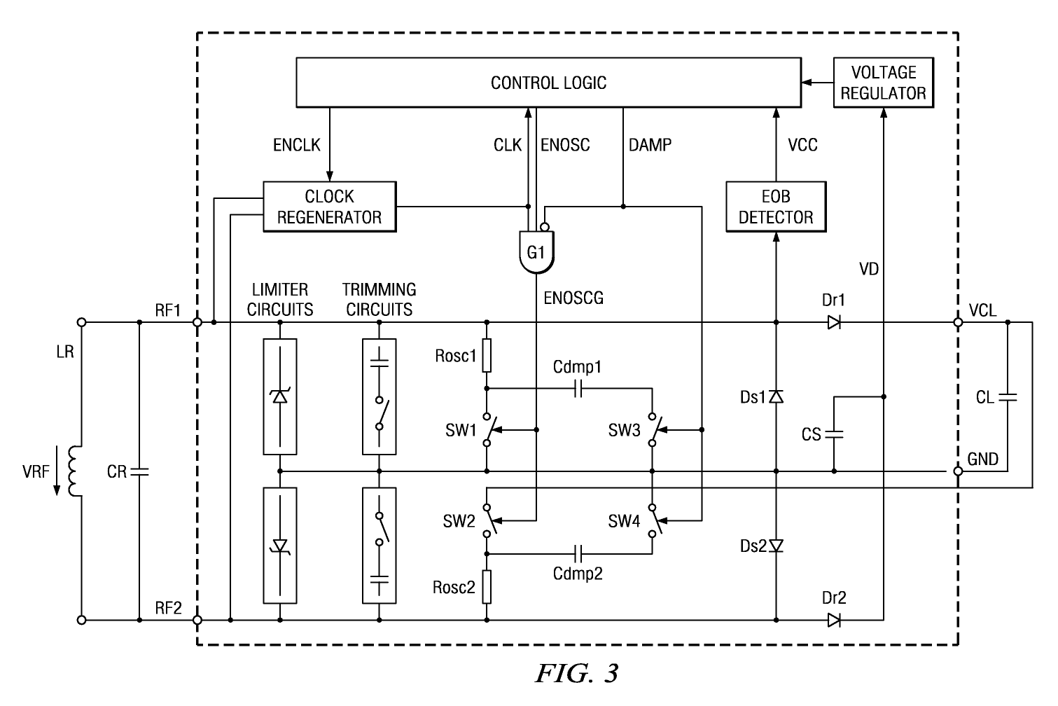

The dashed lines in FIG. 1 and also in FIGS. 2 and 3 indicate a possible partitioning of integrated and non-integrated parts of the circuitry. Accordingly, the components within the dashed rectangle are preferably integrated in an integrated circuit (e.g. a die of silicon, i.e. a chip) and the components outside the dashed rectangle are separately provided and added to the integrated circuit after manufacturing the chip.

FIG. 2 shows a second embodiment of the present invention, which is to a large extent similar to the embodiment shown in FIG. 1. However, this embodiment has no damping capacitors Cdmp1 and Cdmp2. The damping is performed with resistors Rosc1 and Rosc2 only. The bridge rectifier, and in particular diodes Dr1, and Dr2 decouple the supply voltage node VCL from nodes RF1 and RF2, such that the nodes can be pulled down without drawing current from VCL. Therefore, the damping capacitors Cdmp1 and Cdmp2 can be omitted. This results in a stronger damping and the data transmission rate during downlink can be further increased.

FIG. 3 shows a simplified circuit diagram of a third embodiment of the present invention. The embodiment shown in FIG. 3 is basically similar to the one shown in FIG. 1, except that a second supply voltage VD is generated from a half-wave of the received RF signal. The other half-wave of the received RF signal is used to generate the supply voltage VCL. The second supply voltage VD is used to supply the control logic and other digital parts of the RFID transponder. The supply voltage VCL is used to supply analog parts of the RFID transponder. Therefore, the rectifier, including the four diodes Dr1, Dr2, Ds1, and Ds4 is partitioned into two parts, one including Dr1, and Ds1, and the other including Ds2, and Dr2. The buffer capacitor CS is used to buffer the second supply voltage VD. Since the digital parts of the circuit consume less power than the analog parts, the second supply voltage VD can rise much faster during a charging phase than the supply voltage VCL used for the analog parts. This provides for a safe and early initialization (for example reset) of the RFID transponder and prevents malfunctioning of the circuit.

In particular, during a charge-up phase (charge phase), the clock regenerator stage can be turned off. Therefore, the logic circuit used in this stage does not consume any power and the voltage VCC (for the control logic) can increases faster than VCL. The response amplitude at the resonant circuit LR, CR depends on both voltages. VCC will not be significantly lower than VCL, as VCC is refreshed by the maintained oscillation.

The third embodiment shown in FIG. 3 can also be adapted to perform damping without damping capacitors Cdmp1 and Cdmp2 similar to the embodiment of FIG. 2. This the diodes Dr1 and Dr2 will then prevent current from flowing back from VD to RF2 and from VCL to RF1, respectively. The data rate can be increased due to the higher damping without capacitors.

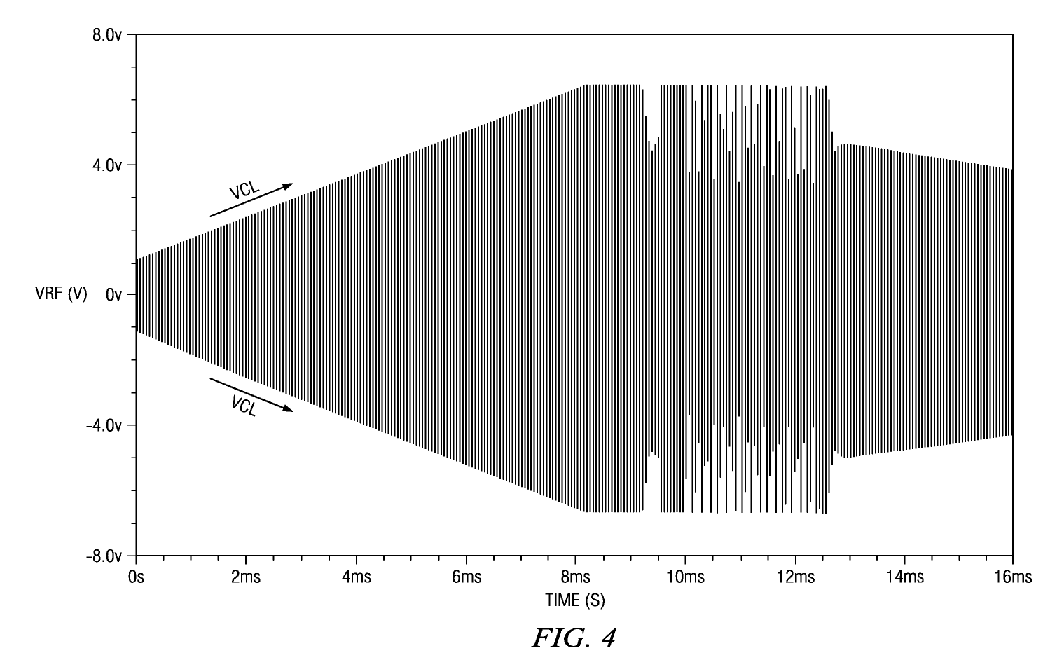

FIG. 4 shows the waveform of the voltage VRF of the embodiment of FIG. 1. It is apparent that the oscillation is strictly symmetric with respect to ground (0 V). The waveform includes a charging phase of about 10 ms, followed by a data transmission in a 100% amplitude shift keying modulation (between 10 ms and 12.5 ms) followed by a deactivation of the RF signal from the R/W-unit (between 12.5 ms and 16 ms).

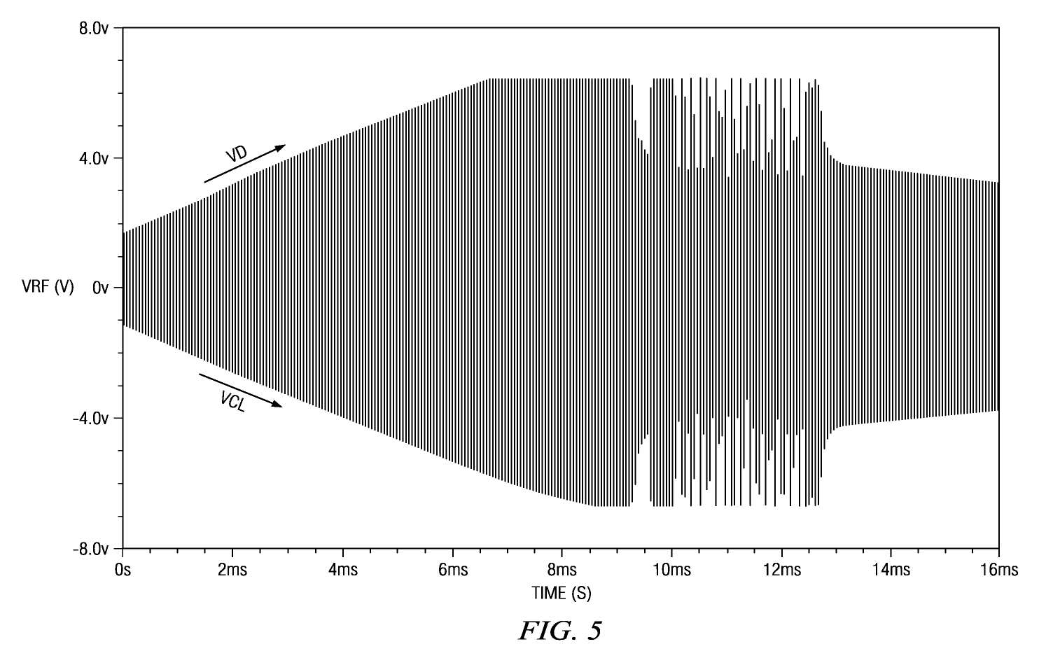

FIG. 5 shows the voltage VRF for the third embodiment shown in FIG. 3. The rising slopes during the first 6 ms are not symmetric with respect to 0V. This is due to the two supply voltages VCL and VD drawn from RF1 and RF2 respectively. The positive side (upper half of the waveform in FIG. 5) rises quicker than the negative side (lower half). The positive side relates to VD and the negative side to VCL.

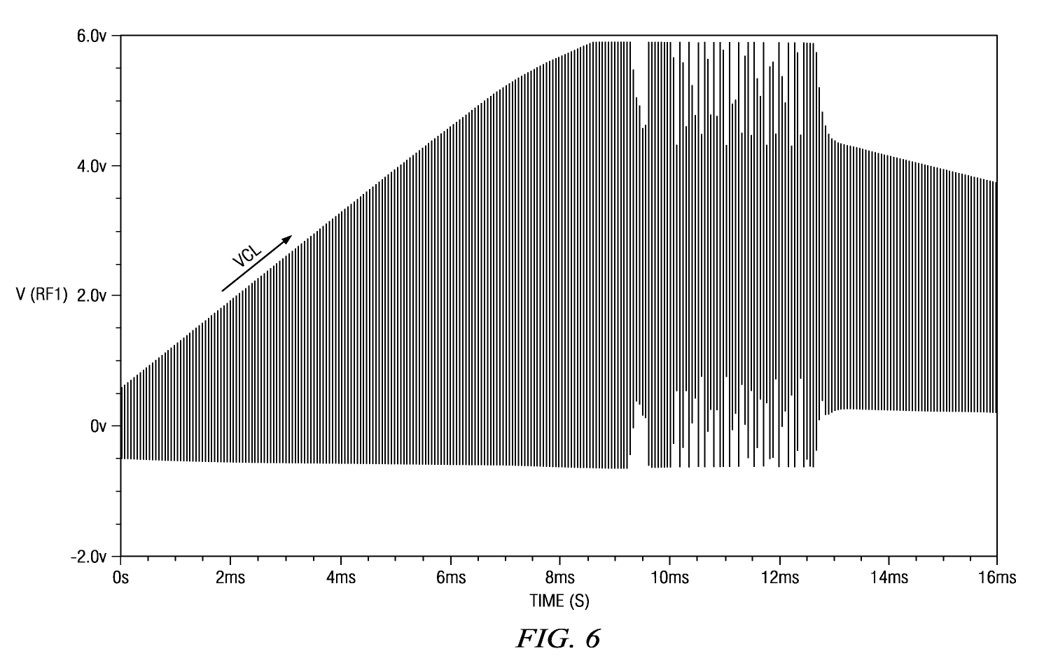

FIG. 6 shows the voltage level at node RF1 with respect to ground (0 V) for the signal shown in FIG. 5.

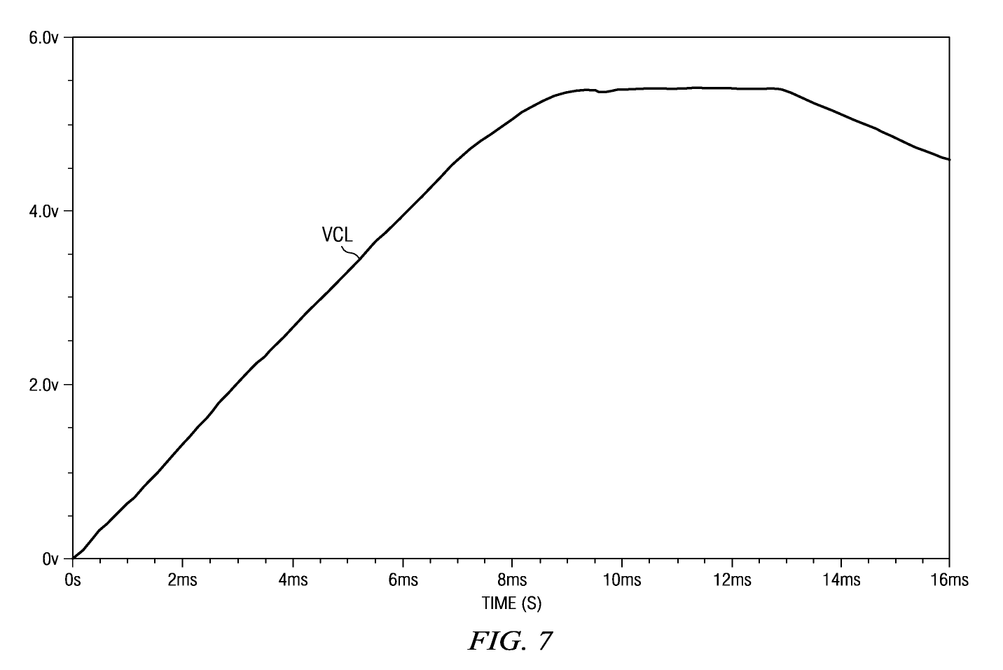

FIG. 7 is the corresponding VCL, which is derived from the signal at node RF1 shown in FIG. 6. The first supply voltage VCL rises smoothly during the charging phase and drops, when the external RF signal stops. This occurs between 12 ms and 13 ms.

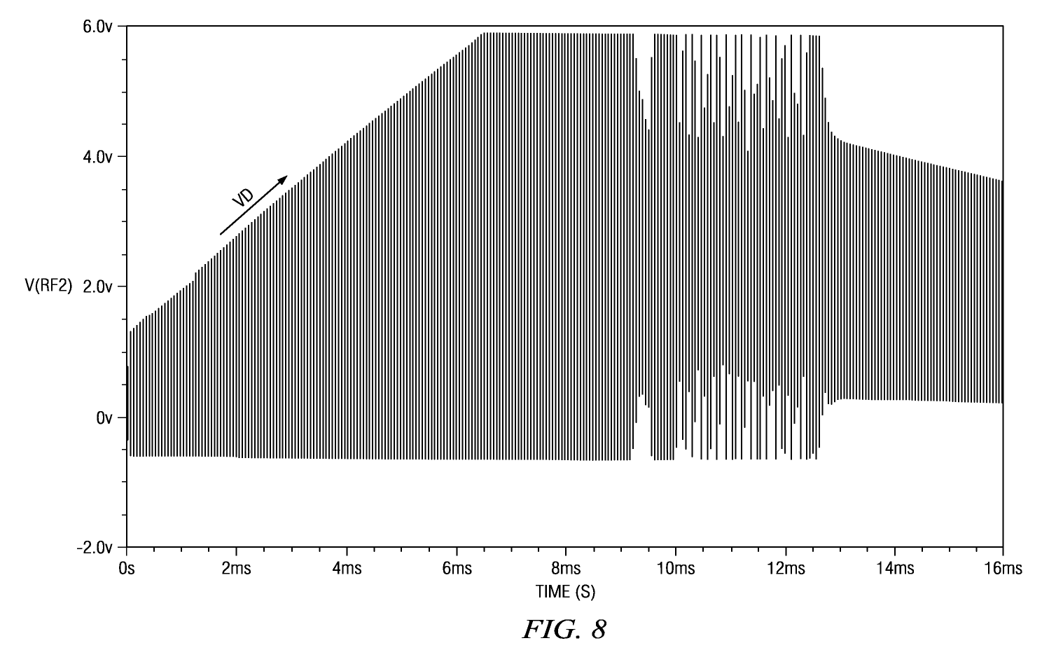

FIG. 8 is the other half wave of the waveform in FIG. 5, i.e. the voltage between RF2 and ground. The signal shown in FIG. 8 is used to generated VD.

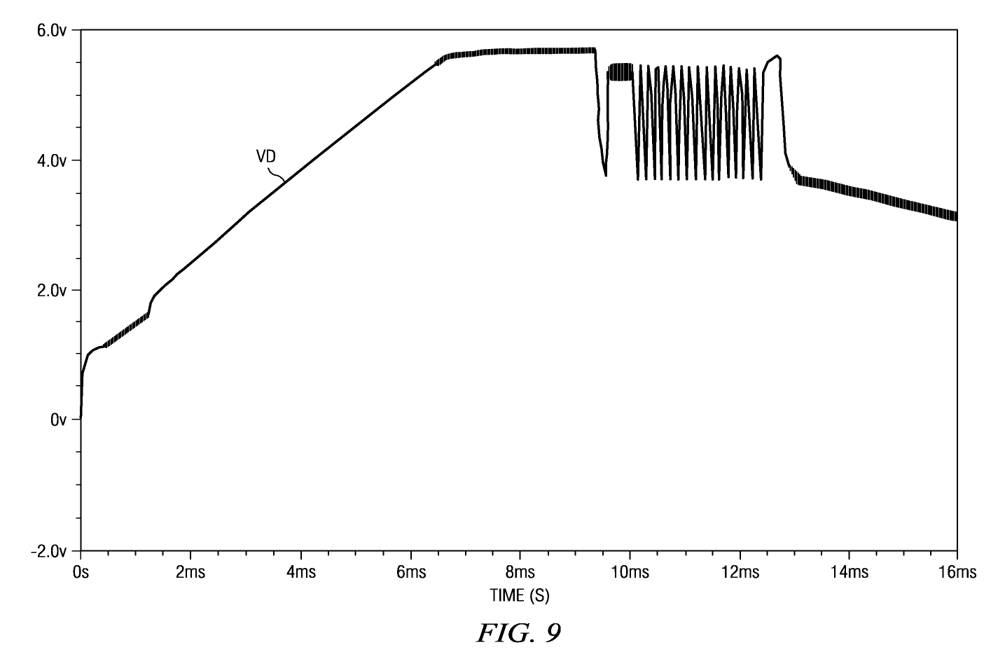

The corresponding supply voltage level VD is shown in FIG. 9. Due to the rather small buffer capacitor CS, the second supply voltage VD drops rather quickly when the external excitation stops. During OFF periods of the downlink data transmission between approximately 9 ms and 12.5 ms, the second supply voltage level goes up and down in accordance with the activation and deactivation scheme of the RF signal at the second node RF2.

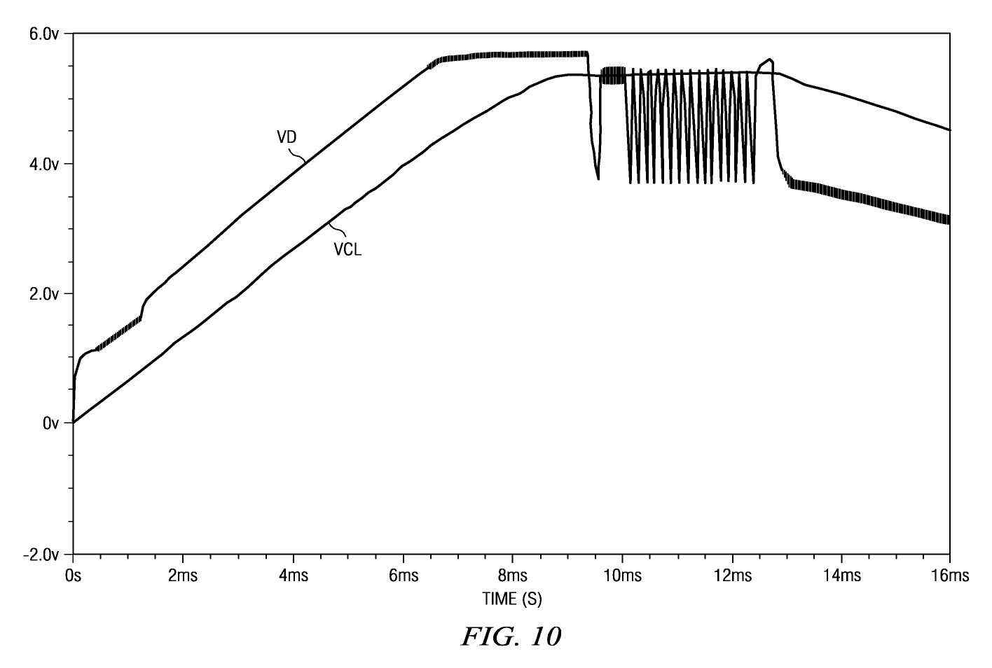

FIG. 10 shows the second supply voltage VD of FIG. 9 and the first supply voltage VCL of FIG. 7 in a single diagram. Accordingly, the second supply voltage VD rises faster than the first supply voltage, which provides for a quick and early initialization of the digital parts of the circuit. However, any breaks in the transmission of the RF signal are also visible in the voltage level of the second supply voltage VD due to the rather small capacitance value of CS. The first supply voltage VCL rises slower but remains more stable due to a large buffer capacitor CL.

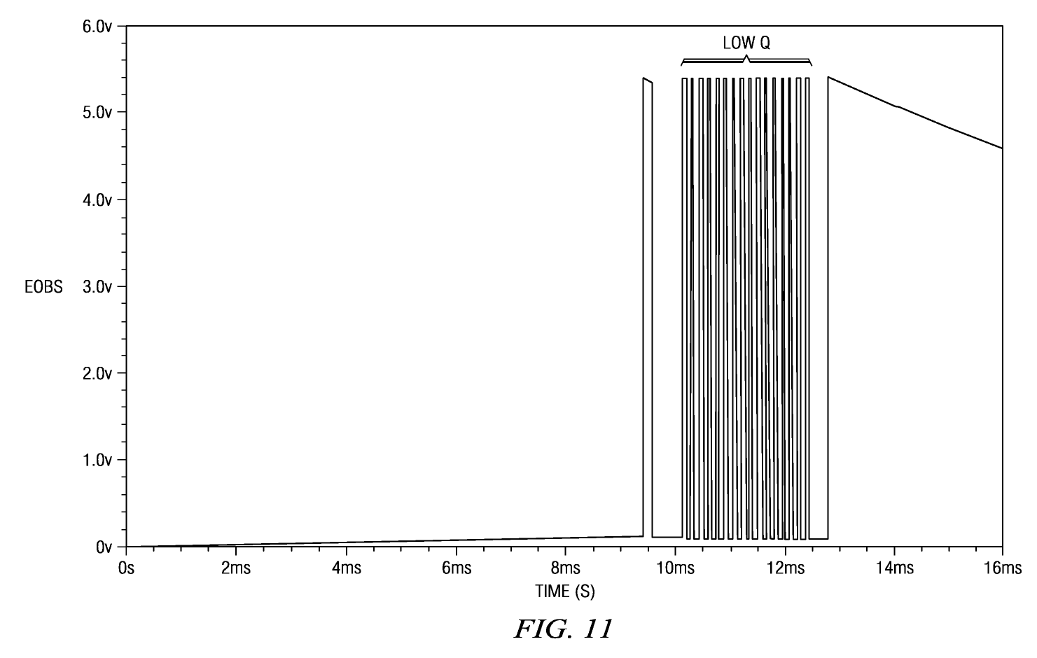

FIG. 11 shows the end-of-burst signal EOBS for the signal shown in FIG. 5 and for the third embodiment. After a rather long pause between 9.5 ms and 10 ms the damping is activated and data can be received with a high data rate, which is illustrated by the frequent level changes between 10 ms and 12.5 ms. Accordingly, the end-of-burst detector EOB is able to detect OFF and ON periods of the RF signal with a high data rate due to the inventive adjustment of the quality factor of the resonant circuit.

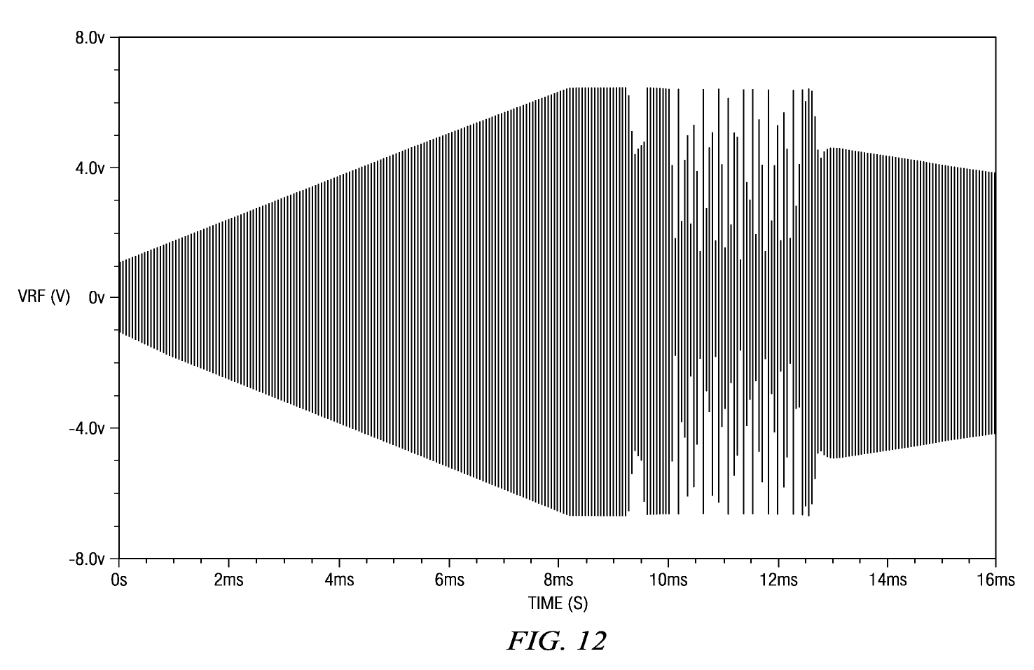

FIG. 12 shows the voltage VRF for the second embodiment shown in FIG. 2. The damping is now performed without damping capacitors by directly coupling the damping resistors Rosc1 and Rosc2 to ground. Therefore, the damping is stronger than with the embodiment shown in FIG. 1, and the data rate can be further increased.

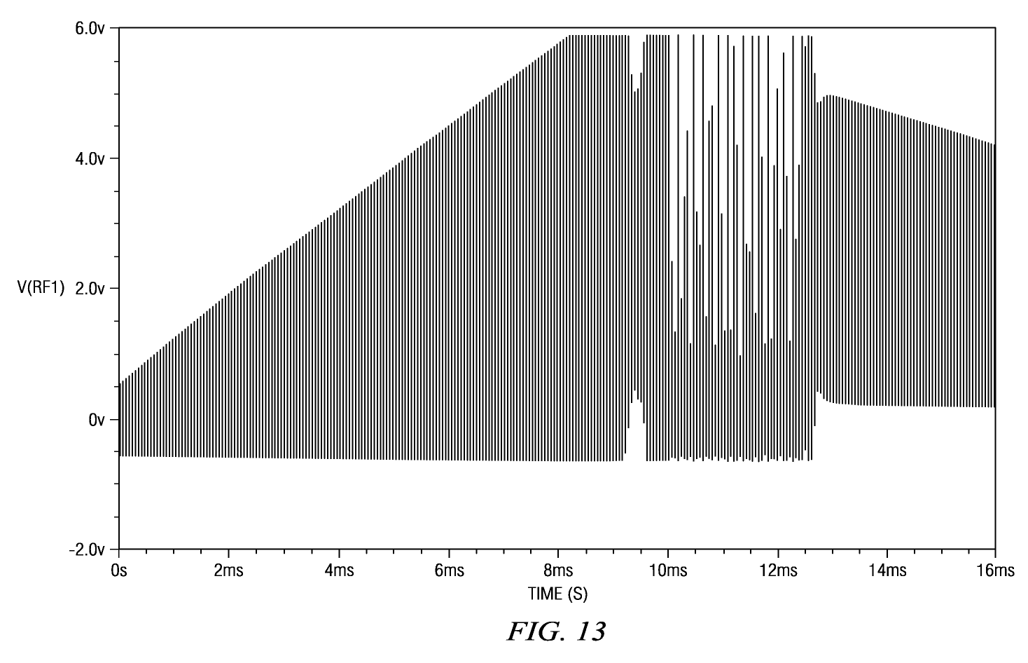

FIG. 13 shows the voltage level at node RF1 for the waveform shown in FIG. 12. The modulation around 0V (ground) is only very little. The modulation with respect to VCL is rather strong, as the positive half wave is damped even stronger in this embodiment. The detection level for the EOB detector should therefore be defined with respect to VCL (VCL−1V) rather than with respect to ground (e.g. GND−1V). However, also in this configuration, the detection level should be adjustable or self-adjusting for optimum performance.

Although the present invention has been described with reference to a specific embodiment, it is not limited to this embodiment and no doubt alternatives will occur to the skilled person that lie within the scope of the invention as claimed.

1. A RFID transponder comprising:
a high quality factor antenna (LR);
a resonance capacitor (CR) coupled to the high quality factor antenna (LR) for providing a resonant circuit (LR, CR), wherein the RFID transponder has a symmetrical RF input stage and is adapted to vary the quality factor of the resonant circuit (LR, CR) such that the quality factor is low during downlink data transmission when the RFID transponder receives data through the antenna (LR), and the quality factor is high during uplink data transmission, when the RFID transponder transmits data.

2. The RFID transponder according to claim 1, wherein the quality factor is high during a charging phase during which the RFID transponder is charged by use of an RF signal.

3. The RFID transponder according to claim 1, further comprising a single demodulation stage (EOB) adapted to detect an end of burst of a RF signal received using the high quality factor and adapted to detect an end of burst of a RF signal received using the low quality factor by use of a same reference detection level.

4. The RFID transponder according to claim 1, further comprising rectifying means for rectifying the received RF signal adapted to rectify different half waves of the received RF signal separately, and to generate a first supply voltage from one half wave and a second supply voltage from the other half wave.

5. The RFID transponder according to claim 4, wherein the first supply voltage is used for supplying analog circuitry and the second supply voltage is used for supplying digital circuitry of the RFID transponder.

6. The RFID transponder according to claim 1, wherein the high quality inductor (LR) and the resonance capacitor (CR) are coupled to each other at a first node (RF1) and a second node (RF2) to form the resonant circuit, the RFID transponder further comprising a first damping resistor (Rosc1) adapted to be selectively coupled between the first node (RF1) and ground, and a second damping resistor (Rosc2) adapted to be selectively coupled between the second node (RF2) and ground.

7. The RFID transponder according to claim 6, further comprising a series of a first damping resistor (Rosc1) and a first damping capacitor (Cdmp1) adapted to be selectively coupled between the first node (RF1) and ground, and a series of a second damping resistor (Rosc2) and a second damping capacitor (Cdmp2) adapted to be selectively coupled between the second node (RF2) and ground.

8. The RFID transponder according to claim 6, further comprising an oscillation maintenance stage, wherein the oscillation maintenance stage comprises two resistors to be selectively coupled to the first node and the second node, and the two resistors are adapted to be used as the first and the second damping resistor.

9. A RFID system having a reader-unit and a RFID transponder, the RFID transponder comprising: a high quality factor antenna (LR), and a resonance capacitor (CR) coupled to the high quality factor antenna (LR) for providing a resonant circuit (LR, CR), wherein the RFID transponder has a symmetrical RF input stage and is adapted to vary the quality factor of the resonant circuit (LR, CR) such that the quality factor is low during downlink data transmission when the RFID transponder receives data through the antenna (LR), and the quality factor is high during uplink data transmission, when the RFID transponder transmits data.

10. A method of operating a RFID transponder, the method comprising:
switching a resonant circuit of the RFID transponder for receiving and transmitting a RF signal to a low quality factor during downlink data transmission; and
switching to a high quality factor during uplink data transmission by use of symmetrical damping means.

11. The method according to claim 10, further comprising generating a first supply voltage from a first half wave of a received RF signal and generating a second supply voltage from a second half wave of the received RF signal.

12. The method according to claim 11, further comprising using the first supply voltage for supplying analog parts of the RFID transponder and using the second supply voltage for supplying digital parts of the RFID transponder.

13. The RFID transponder according to claim 2, further comprising a single demodulation stage (EOB) adapted to detect an end of burst of a RF signal received using the high quality factor and adapted to detect an end of burst of a RF signal received using the low quality factor by use of a same reference detection level.

14. The RFID transponder according to claim 2, further comprising rectifying means for rectifying the received RF signal adapted to rectify different half waves of the received RF signal separately, and to generate a first supply voltage from one half wave and a second supply voltage from the other half wave.

15. The RFID transponder according to claim 3, further comprising rectifying means for rectifying the received RF signal adapted to rectify different half waves of the received RF signal separately, and to generate a first supply voltage from one half wave and a second supply voltage from the other half wave.

16. The RFID transponder according to claim 2, wherein the high quality inductor (LR) and the resonance capacitor (CR) are coupled to each other at a first node (RF1) and a second node (RF2) to form the resonant circuit, the RFID transponder further comprising a first damping resistor (Rosc1) adapted to be selectively coupled between the first node (RF1) and ground, and a second damping resistor (Rosc2) adapted to be selectively coupled between the second node (RF2) and ground.

17. The RFID transponder according to claim 3, wherein the high quality inductor (LR) and the resonance capacitor (CR) are coupled to each other at a first node (RF1) and a second node (RF2) to form the resonant circuit, the RFID transponder further comprising a first damping resistor (Rosc1) adapted to be selectively coupled between the first node (RF1) and ground, and a second damping resistor (Rosc2) adapted to be selectively coupled between the second node (RF2) and ground.

18. The RFID transponder according to claim 4, wherein the high quality inductor (LR) and the resonance capacitor (CR) are coupled to each other at a first node (RF1) and a second node (RF2) to form the resonant circuit, the RFID transponder further comprising a first damping resistor (Rosc1) adapted to be selectively coupled between the first node (RF1) and ground, and a second damping resistor (Rosc2) adapted to be selectively coupled between the second node (RF2) and ground.

19. The RFID transponder according to claim 5, wherein the high quality inductor (LR) and the resonance capacitor (CR) are coupled to each other at a first node (RF1) and a second node (RF2) to form the resonant circuit, the RFID transponder further comprising a first damping resistor (Rosc1) adapted to be selectively coupled between the first node (RF1) and ground, and a second damping resistor (Rosc2) adapted to be selectively coupled between the second node (RF2) and ground.

20. The RFID transponder according to claim 7, further comprising an oscillation maintenance stage, wherein the oscillation maintenance stage comprises two resistors to be selectively coupled to the first node and the second node, and the two resistors are adapted to be used as the first and the second damping resistor.
